(19) United States
(12) Patent Application Publication
(10) Pub. No.: US 2025/0067444 A1
(43) Pub. Date: Feb. 27, 2025

(54) BOILER INDUCTION HEATING SYSTEM

(71) Applicant: Hertzel YAICH, Kfar Saba (IL)

(72) Inventor: Hertzel YAICH, Kfar Saba (IL)

(21) Appl. No.: 18/724,630

(22) PCT Filed: Dec. 28, 2022
(86) PCT No.: PCT/IL2022/051407

§ 371 Date: Jun. 27, 2024

(30) Foreign Application Priority Data
Dec. 29, 2021 (IL) 289495

(51) Int. Cl. F24D 17/00; H05B 6/10; H05B 6/80

(52) U.S. Cl. CPC F24D 17/0036; H05B 6/108; H05B 6/804

(57) ABSTRACT

In one aspect, the present invention is directed to boiler heating system, comprising: a hollowed-walls cylinder, for storing therein water to be heated; a partition in a form of a cylinder, disposed inside the hollowed-walls cylinder, distantly from its vertical walls; the partition having an upper water passage and a lower water passage, for allowing water transition between the inner side of the partition and the outer side of the partition; a heating element based on induction heating, said heating element being disposed inside the inner space of the hollowed-walls cylinder; a water inlet, disposed in the lower side of the hollowed-walls cylinder; and a water outlet, disposed in an upper side of the hollowed-walls cylinder, thereby (a) allowing heating the water without being in direct contact between the heating element and the water, resulting with no scale accumulation, and (b) separation between ascending water and descending water, thereby accelerating the water warming.

### TECHNICAL FIELD

The present invention relates to the field of boiler heating technology.

### BACKGROUND ART

Presently, boiler heating systems are mainly based on electricity heating and gas heating. These systems are characterized by having many drawbacks. For example, one of the drawbacks is the heating rate, and therefore many attempts have been made to increase the rate of warming of the water.

In addition, after several heating sessions with an electrical heating element, scale is accumulated on the heating element. The scale isolates the heating element from the water to be heated, and therefore not only the warming rate is slowed, but also more energy is consumed.

Furthermore, in order to replace a heating element which has been covered with scale, the water in the boiler must be emptied, and therefore this water is wasted. In addition, scale cleaning is a difficult and cumbersome action, and sometimes therefore it is common to replace the entire heating element.

In summary, the present water heating technologies are characterized by slow heating rate, waste of energy, amortization and maintenance.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to boiler heating system (100), comprising:
a hollowed-walls cylinder (12), for storing therein water to be heated;
a partition (13) in a form of a cylinder, disposed inside the hollowed-walls cylinder (12), distantly from its vertical walls;
the partition having an upper water passage (18) and a lower water passage (19), for allowing water transition between the inner side of the partition (chamber H) and the outer side of the partition (chamber A);
a heating element (15) disposed inside the inner space of the hollowed-walls cylinder (chamber C, referred also as combustion chamber);
a water inlet (10), disposed in the lower side of the hollowed-walls cylinder (12);
a water outlet (11), disposed in an upper side of the hollowed-walls cylinder (12);
an adapter, for generating alternate current of desired characteristics through said heating element such that said heating element generates induction heating in a distant electricity conductive element,
thereby (a) allowing heating the water without being in direct contact between the heating element and the water, resulting with no scale accumulation, and (b) separation between ascending water and descending water, thereby accelerating the water warming.

The system may further comprise a lid (17) of the inner space (chamber C) in which the heating element (15) is disposed, for adjusting a heating rate of the system.

The system may further comprise means for adjusting the space inside the partition (not shown), such as a telescopic form of the partition, thereby adjusting the heating rate of the water.

The heating element may be electric as well as based on combustion, such as a flame.

According to one embodiment of the invention, the space of chamber A is divided by partitions (24) each having a hole (25), thereby moderating the cooling rate of the heated water.

According to one embodiment of the invention, the heating element (15) is in a form of a spiral.

According to one embodiment of the invention, the induction heating mechanism is in a form of a coil (28) coiled around a rod (29) made of electrically conductive material.

According to another embodiment of the invention, the induction heating mechanism is in a form of a coil (28) disposed inside the combustion chamber, and wherein the wall of the combustion chamber is made of electrically conductive material.

According to a further embodiment of the invention, the induction heating mechanism comprises an adapter (27) to be connected between an electric power source (26) and the coil (28), for generating alternating current to the coil (28) such that the heat generated by the rod (29) is according to desired characteristics.

According to another embodiment of the invention, the induction heating mechanism is in a form of one or more magnetrons rotatable by a rotating mechanism (such as a motor). In this case the wall of the hollowed-walls cylinder (chamber C) is of a material that allows magnetron waves to pass therethrough, for allowing magnetron waves to reach the water of the boiler heating system.

Preferably the magnetron(s) is disposed at the lower side of the hollowed-walls cylinder (chamber C), however they can be placed also in a higher side thereof.

According to another embodiment of the invention, the magnetron(s) are stationary.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 pictorially illustrates a boiler heating system 100, according to one embodiment of the invention.

FIG. 2 is a sectioned view of the boiler heating system.

FIG. 3 is a front view of the boiler heating system, in which is defined a section A-A.

FIG. 4 is a perspective view of section A-A.

FIG. 5 is a front view of section A-A.

FIG. 6 is a front view of section A-A in which is illustrated the water circulation thereof.

FIG. 7 is a sectional view of a boiler heating system, according to a further embodiment of the invention.

FIG. 8 schematically illustrates an induction heating device, according to the prior art.

FIG. 9 is a longitudinal cross-section schematically illustrating a boiler heating system 100 heated by induction heating, according to one embodiment of the invention.

FIG. 10 is a longitudinal cross-section schematically illustrating a boiler heating system 100 heated by induction heating, according to one embodiment of the invention.

FIGS. 11a, 11b and 11c schematically illustrate a boiler heating system 100 heated by induction heating, according to one embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

### The System Structure

The tank of the system 100 is in the form of a vertical cylinder having hallowed walls, which stores the water. Thus, while the prior art boiler have a tank in a form of a vessel, a water tank according to the present invention is a vertical cylinder having hollowed walls, in which the water is disposed. Accordingly, the center of the tank is a hollowed cylinder.

A heating element is placed inside the space in the center of the hollowed cylinder. Thus, the heating element can be electric, such as a spiral, or even fire.

The space of the hollowed walls of the cylinder is divided by a partition in a form of a vertical cylinder. Nevertheless, the partitioning cylinder allows water passage from its upper side and from its lower side, in order to allow circulation, as detailed hereinafter.

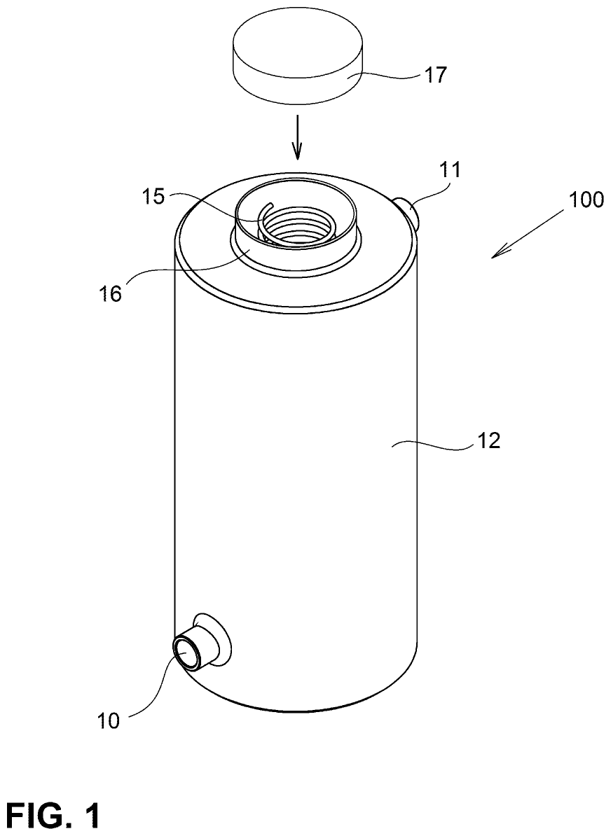

FIG. 1 pictorially illustrates a boiler heating system 100, according to one embodiment of the invention.

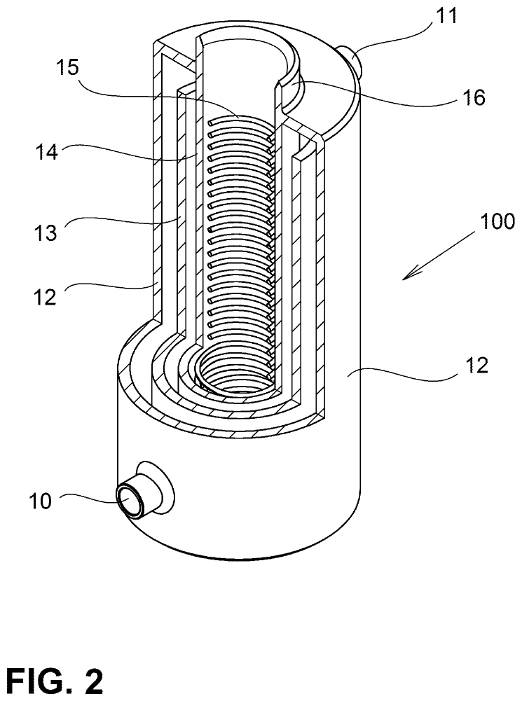

FIG. 2 is a sectioned view of the boiler heating system.

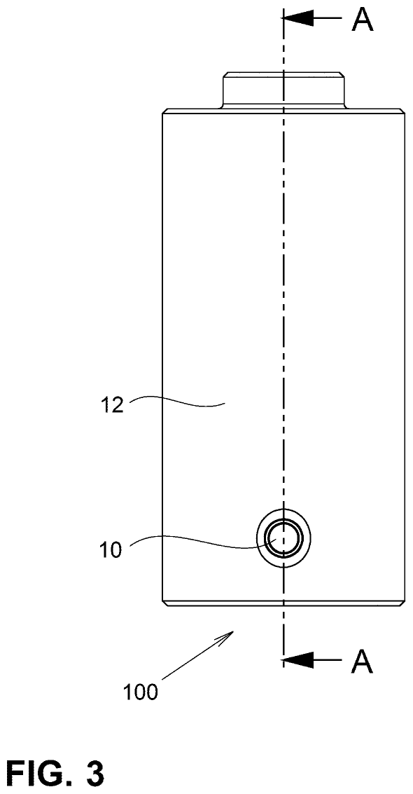

FIG. 3 is a front view of the boiler heating system, in which is defined a section A-A.

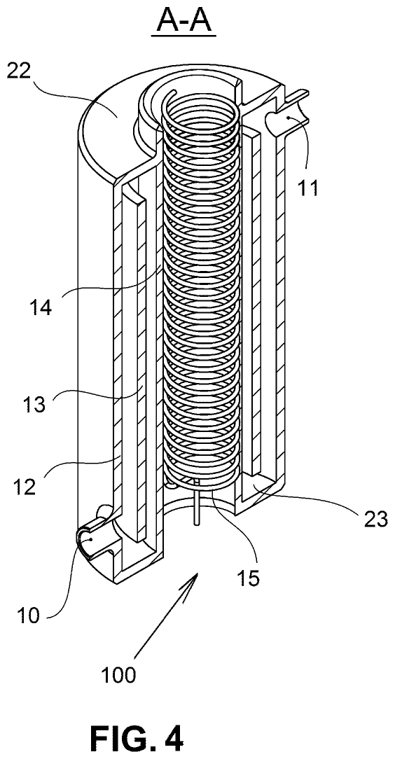

FIG. 4 is a perspective view of section A-A.

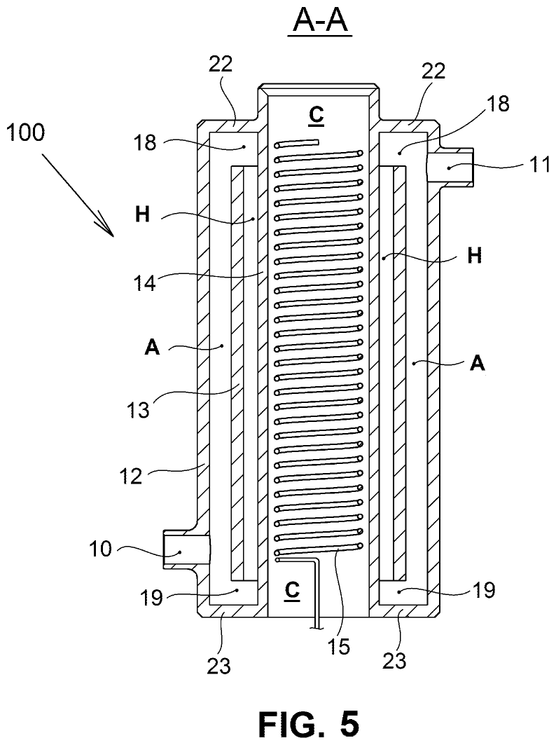

FIG. 5 is a front view of section A-A.

The water tank is confined by the external cylinder wall 12 and internal cylinder wall 14, and the upper and lower “lids” 22 and 23 respectively.

Inside the water tank is disposed a partition in a form of a vertical cylinder 13. The partition prevents water passage through it. The partition 13 does not meet the “lids” 22 and 23, and more particularly, there are gaps 18 and 19 between cylinder 13 and the “lids” 22 and 23, for allowing water passage through the gaps. The gaps are better seen in FIG. 5.

According to one embodiment of the invention, the partition 13 meets the “lids” 22 and 23, and the gaps are replaced by holes in the upper and lower side of the partition 13. For the sake of brevity, this embodiment is not illustrated.

As such, this structure defines three chambers:
Chamber C, which is the interior side of cylinder 14. Chamber C is referred herein as a Combustion Chamber;
Chamber H, which is confined by cylinders 13 and 14, i.e., the space between the partition 13 and the cylinder 14. This chamber is referred herein as Heating Chamber; and
Chamber A which is the space confined by cylinder 12 and cylinder 14, excluding the space of chamber H. This chamber is referred herein as Accumulating Chamber.

The tank is the space of chambers A and H.

Reference numeral 10 denotes an inlet through which non-heated water enter into the water tank of the boiler, and reference numeral 11 denotes an outlet from the tank, through which heated water exits the tank.

### The System Operation

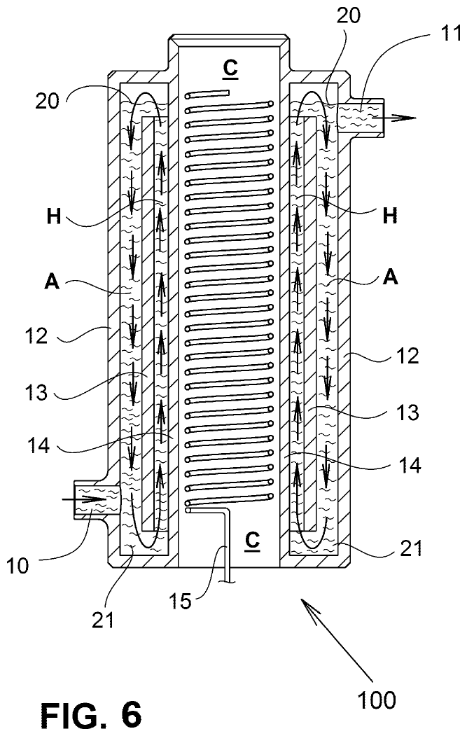

FIG. 6 is a front view of section A-A in which is illustrated the water circulation of the illustrated system.

Cylinder 14 is heated by the heating element 15. As a result, the water disposed in chamber H is heated, and therefore moves upwards.

Due to the apertures 18 and 19 between the partition 13 and the “lids” 22 and 23, the heated water of chamber H is in contact with the water of chamber A. As a result the water of chamber A, which is colder than the water of chamber H, moves downwards. Thus, the water inside the tank circulates as illustrated in this figure by the arrows.

The relation between the space of the heating chamber H and the space of the accumulating chamber A determines the heating rate of the water in the tank.

Since in the present invention the water of the tank is not in direct contact with the heating element 15, no scale is generated. As a result, the system lasts longer than systems in which water is heated while being in direct contact with the heating element. Furthermore, in the present invention lesser maintenance activity is required, since the main maintenance activity in the prior art boilers is due to the accumulated scale.

The present invention heats a boiler's water in less time than a prior art boiler with the same characteristics, so the energy consumed by the present invention is lesser in comparison to the prior art boiler. The reason thereof is separation between ascending water and descending water inside the boiler, in contrast to prior art boilers in which ascending water is mixed with descending water and therefore interfere with each other.

Referring again to FIG. 1, the lid 17 is used to close the combustion chamber C, thereby maintaining the heated air in the combustion chamber, and therefore using less energy for heating the boiler. The lid 17 can be partially released such that a generated aperture between the lid and the “neck” 16 is adjusted, thereby adjusting the heating speed of the water of the boiler.

According to a preferred embodiment of the invention, the dimensions of partition 13 are adjustable. By adjusting a dimension of partition 13, the relation between the volume of chamber A and chamber H are changed, and therefore the heating speed of the system is changed.

Adjusting the partition's dimensions can be carried out by a variety of ways. For example, the partition wall 13 may be designed as telescopic, and therefore its length is adjustable. Controlling the extension of the telescopic cylinder may be carried out by a rod connected to one part of the telescopic cylinder, such that the rod outstands from one of the facets 23 or 24.

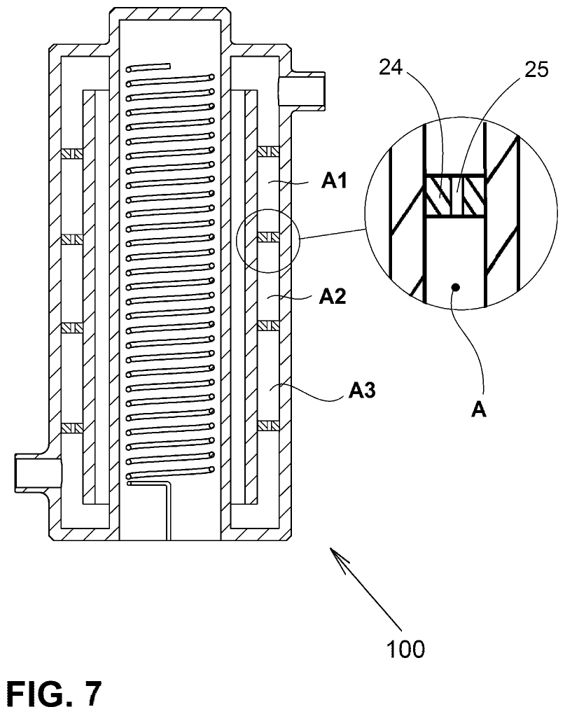

FIG. 7 is a sectional view of a boiler heating system, according to a further embodiment of the invention.

FIG. 7 also illustrates a zoomed view of a part of the system.

As shown, a plurality of partitions 24 is installed in chamber A. Each partition comprises a bore 25 which is used as water passage between the sub chambers. The partitions divide the space of chamber A to sub-chambers A1, A2, . . . , An.

Since the sub chambers are separated from each other, this arrangement provides some isolation which moderates the cooling rate of the heated water.

Preferably, the cylinders 12, 13 and 14, and also the facets 22 and, 23 are made of metal, but of course other materials known in boilers industry may be used.

### Induction Heating

“Induction heating is the process of heating electrically conductive materials like metals by electromagnetic induction, through heat transfer passing through an induction coil that creates an electromagnetic field within the coil to melt down steel, copper, brass, graphite, gold, silver, aluminum, and carbide.” (From Wikipedia, Induction heating).

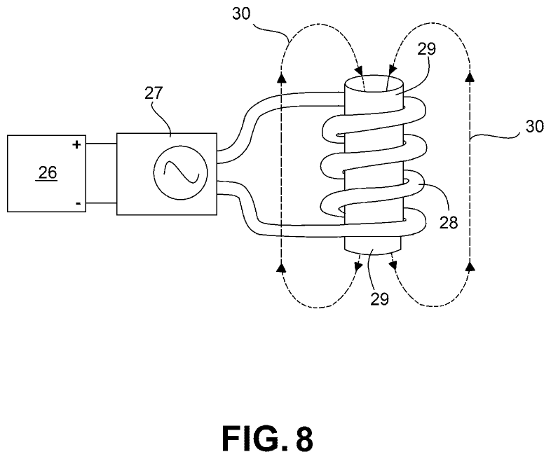

FIG. 8 schematically illustrates an induction heating device, according to the prior art.

Reference numeral 26 denotes an electric power source, whether being direct or alternate. Numeral 27 denotes an adapter for setting and adjusting its output alternate current with desired characteristics, such as frequency and intensity. Adapter 27 is connected to the power source 26. Numeral 28 denotes a coil, connected to the adapter 27, and numeral 29 denotes an electrically conductive rod around which coil 28 is coiled. Current flow in adapter 27 causes alternating current with desired characteristics to flow through coil 28, and consequently the magnetic field 30 cause rod 29 to heat.

It should be noted that the coil may be coiled outside the rod as illustrated in FIG. 8, inside the rod, or beside the rod.

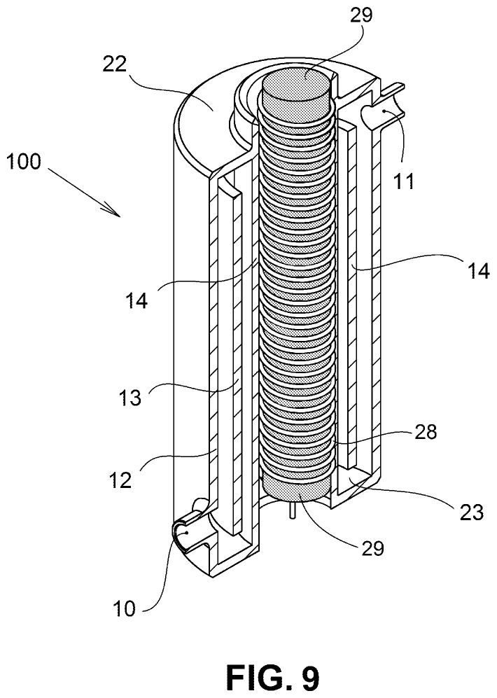

FIG. 9 is a longitudinal cross-section schematically illustrating a boiler heating system 100 heated by induction heating, according to one embodiment of the invention.

As illustrated, the metal rod 29 which is disposed inside the combustion chamber (cylinder 14 is its wall) is heated.

For the sake of clarity, the adapter (reference numeral 27 in FIG. 8) is not illustrated in this figure.

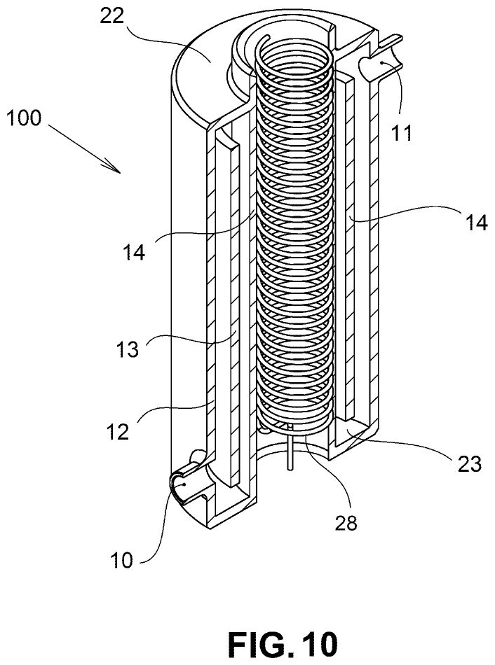

FIG. 10 is a longitudinal cross-section schematically illustrating a boiler heating system 100 heated by induction heating, according to one embodiment of the invention.

In comparison to the embodiment illustrated in FIG. 9, in the embodiment of FIG. 10 the rod around which the coil is coiled is absent. Thus, instead of heating the rod, the cylinder 14 is heated.

For the sake of clarity, the adapter (reference numeral 27 in FIG. 8) is not illustrated in this figure.

### Heating by Magnetron

From a point of view of the present invention, the term “magnetron” refers herein to a tube capable of producing electromagnetic waves capable of heating water.

There are materials that block the waves produced by a magnetron, and there are materials which allow magnetron waves to pass therethrough.

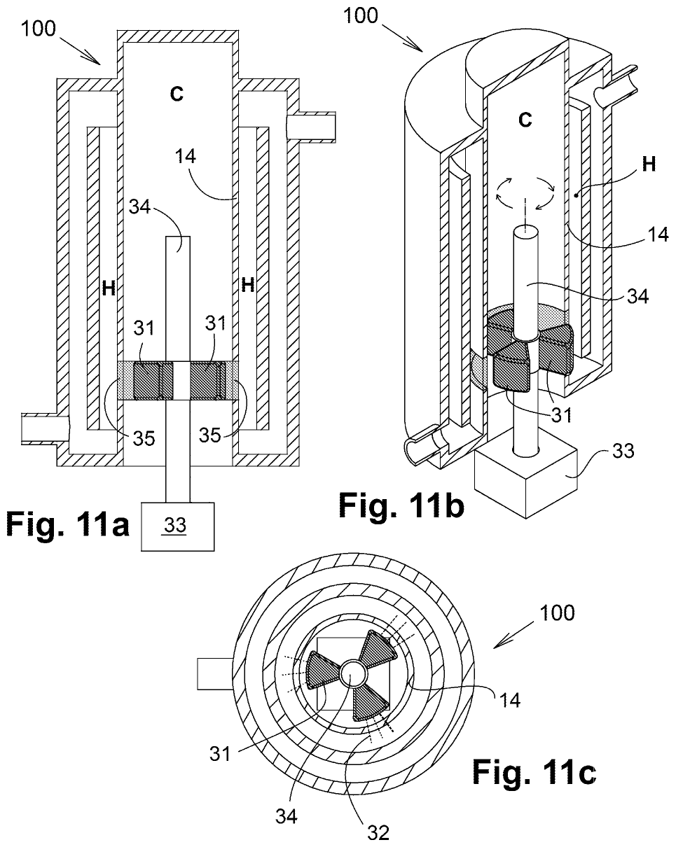

FIGS. 11a, 11b and 11c schematically illustrate a boiler heating system 100 heated by induction heating, according to one embodiment of the invention.

FIG. 11a is a longitudinal sectioned view; FIG. 11b is a perspective view; and FIG. 11c is a top view.

A motor 33 rotates a hinge 34 to which are connected one or more magnetrons 31 such that their waves (not illustrated) are directed towards the walls 14 of the combustion chamber C.

Since the waves 32 of magnetrons are directed towards the wall of the combustion chamber C, region 35 of wall 14 that separates the magnetron and the wall of the combustion chamber C is made of a material that allows magnetron waves to pass therethrough. In the illustrated example, the wall 35 is transparent.

The water inside the heating chamber H is heated by the magnetron(s).

Preferably, the magnetron is located at the lower side of the combustion chamber C since heated water move upwards. However, it should be noted that a magnetron can be placed also in a higher location of the combustion chamber.

Actually, even if the magnetrons are stationary, they still heat the water inside the heating chamber H. The decision whether to use one or more magnetrons, stationary or rotatable, is a matter of engineering.

It should be noted that the magnetron waves are illustrated only in FIG. 11c.

In the figures and/or description herein, the following reference numerals and letters (Reference Signs List) have been mentioned:
numeral 100 denotes boiler heating system, according to one embodiment of the invention;
the letter C denotes a combustion chamber;
the letter H denotes a heating chamber;
the letter A denotes an accumulating chamber;
numeral 10 denotes an inlet to the heating system 100;
numeral 11 denotes an outlet from the heating system 100;
numeral 12 denotes a first cylinder;
numeral 13 denotes a second cylinder operable as a partition;
numeral 14 denotes a third cylinder;
numeral 15 denotes a heating element;
numeral 16 denotes a neck correspondingly to lid 17;
numeral 17 denotes a lid;
numeral 18 denotes a space between the upper edge of the second cylinder 13 and the upper wall of chamber A;
numeral 19 denotes a space between the lower edge of the second cylinder 13 and the lower wall of chamber A;
numeral 20 denotes a water line;
numeral 21 denotes water inside the boiler;
numeral 22 denotes a top “lid” (facet) of vertical cylinder confined between cylinders 12 and 14;
numeral 23 denotes a bottom “lid” (facet) of vertical cylinder confined between cylinders 12 and 14;
numeral 24 denotes a partition which separates chamber A into sub chambers;
numeral 25 denotes a water passage in each of the partitions 24;
numeral 26 denotes an electric power source;
numeral 27 denotes an adapter in which its input is electric current (whether direct or alternate current), and its output is alternate current with desired characteristics (such as intensity and frequency);
numeral 28 denotes a coil;
numeral 29 denotes a rod made of an electrically conductive material;
numeral 30 denotes a magnetic field;
numeral 31 denotes a magnetron;
numeral 32 denotes magnetron waves;
numeral 33 denotes a motor that rotates hinge 34;
numeral 34 denotes a hinge; and
numeral 35 denotes a material which allows magnetron waves to pass therethrough.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

1. A boiler heating system, comprising:
a hollowed-walls cylinder, for storing therein water to be heated;
a partition in a form of a cylinder, disposed inside said hollowed-walls cylinder, distantly from its vertical walls;
said partition having an upper water passage and a lower water passage, for allowing water transition between an inner side of said partition and an outer side of said partition;
a heating element disposed inside an inner space of said hollowed-walls cylinder;
a water inlet, disposed in a lower side of said hollowed-walls cylinder;
a water outlet, disposed in an upper side of said hollowed-walls cylinder;
an adapter, for generating alternating current of desired characteristics through said heating element such that said heating element generates induction heating in a distant electricity conductive element;
an induction heating mechanism in a form of one or more magnetrons rotatable by a rotating mechanism, or in a form of a coil made of electrically conductive material and disposed inside said inner space, wherein said coil is free from elements made of electrically conductive material disposed therein, and wherein a wall confining said inner space is made of electrically conductive material,
thereby (a) allowing heating said water without being in direct contact between said heating element and said water, resulting with no scale accumulation, and (b) separation between ascending water and descending water, resulting with accelerating heating of said water.

2. The system according to claim 1, further comprising a lid of said inner space in which said heating element is disposed, for adjusting a heating speed of the system.

3. The system according to claim 1, further comprising means for adjusting a space inside said partition, thereby adjusting a heating rate of said water.

4. The system according to claim 3, wherein said means for adjusting a space inside said partition is a telescopic form of said partition.

5. The system according to claim 1, wherein said heating element is electric.

6. The system according to claim 1, wherein said heating element is based on combustion.

7. The system according to claim 1, wherein a space of said outer side of said partition is divided by partitions with a hole, thereby moderating a cooling rate of heated water.

8. The system according to claim 1, wherein said heating element is in a form of a spiral.

9. The system according to claim 1, wherein said induction heating mechanism comprises an adapter to be connected between an electric power source and said coil, for generating alternating current to said coil such that a heat generated by said rod is according to desired characteristics.

10. The system according to claim 1, wherein said hollowed-walls cylinder is of a material that allows magnetron waves to pass therethrough, for allowing said magnetron waves to reach water of said boiler heating system.

11. The system according to claim 1, wherein said one or more magnetrons are disposed at a lower side of said hollowed-walls cylinder.

12. The system according to claim 1, wherein said one or more magnetrons are disposed at a higher side of said hollowed-walls cylinder.

13. The system according to claim 1, wherein said one or more magnetrons are stationary.
